(19) United States
(12) Patent Application Publication
(10) Pub. No.: US 2004/0027325 A1
(43) Pub. Date: Feb. 12, 2004

(54) Liquid crystal display unit

(76) Inventors: Katsuhiko Suwa, Osaka (JP); Kazunori Terano, Osaka (JP)

Correspondence Address: WENDEROTH, LIND & PONACK, L.L.P., 2033 K STREET N. W., SUITE 800, WASHINGTON, DC, 20006-1021, US

(21) Appl. No.: 10/212,050

(22) Filed: Aug. 6, 2002

(51) Int. Cl. G09G 3/36; G09G 5/00

(52) U.S. Cl. 345/102

(57) ABSTRACT

The liquid crystal display (LCD) unit contains at least a light source for illuminating the LCD unit and one or more illuminating switch responsible for entry operation. Operating brightness control switch allows a control circuit to generate a signal. An inverter circuit according to the signal from the control circuit adjusts brightness of the light source, and brightness of the illuminating switch is controlled by the signal. As a result, the LCD unit can have an adjustment adaptable to various changes in ambient light condition, providing users with greatly improved easy-to-view.

### FIELD OF THE INVENTION

The present invention relates to a liquid crystal display (LCD) unit that is used in combination with a motor-vehicle-mounted computer.

### BACKGROUND OF THE INVENTION

In using a liquid crystal display (LCD) and an input device in combination with a computer, the LCD and input device has been individually formed; or in other cases, a transparent touch panel has been disposed in front of an LCD for input operation. Particularly, using a touch panel in which an input device integrally works with an LCD has required an entry/display integrated software package dedicated to the touch panel. Besides, visibility has often been decreased due to low transmittance of the touch panel and undesired reflections off the surface of the touch panel. For such reasons, an LCD unit equipped with an input device has been now in increasing demand.

When such an LCD unit is used in the open air, it should be highly adaptable to changes in ambient light intensity: it should keep enough brightness under the glare of sunshine in summer, while in the nighttime, the brightness should be adequately weakened for good visual recognition. Particularly in the case that the LCD unit is mounted on a car, police officers in the nighttime patrol could be lighted by reflections off the device, being jeopardized the safety of life.

### SUMMARY OF THE INVENTION

To address the problems above, the LCD unit of the present invention includes: i) a light source; ii) an inverter circuit for feeding power to the light source for light-emitting; iii) a power-supplying circuit for feeding power to the inverter circuit; iv) a control circuit for adjusting brightness of the light source; v) a light-emitting switch responsible for entry operation to an information processor; and vi) a transparent (or translucent) switch member disposed in front of the light-emitting switch. With the structure above, the LCD unit can control output from the inverter circuit according to signals fed from the control circuit, adjusting brightness not only of the light source but also of the light-emitting switch.

### BRIEF DESCRIPTION OF THE DRAWINGS

FIG. 1 is a perspective view of an LCD unit in accordance with a first preferred embodiment of the present invention.

FIG. 2 is a block diagram illustrating a circuit for controlling brightness of a light source in accordance with the first preferred embodiment.

FIG. 3A is a front view of an LCD unit in accordance with a second preferred embodiment.

FIG. 3B is a side view of the LCD unit in accordance with the second preferred embodiment.

FIG. 4A is a front view of an LCD unit in accordance with a third preferred embodiment.

FIG. 4B is a side view of the LCD unit in accordance with the third preferred embodiment.

### DESCRIPTION OF THE PREFERRED EMBODIMENTS

The preferred embodiments of the present invention are described hereinafter with reference to the accompanying drawings.

### First Preferred Embodiment

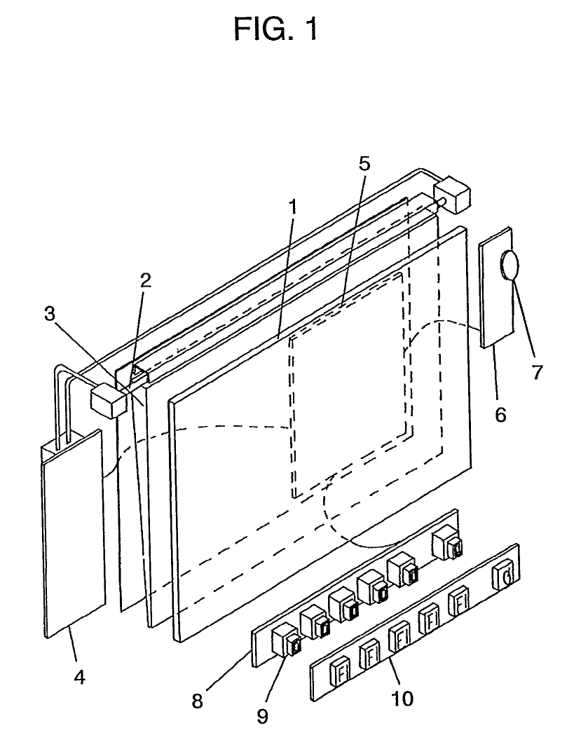

FIG. 1 is a perspective view of an LCD unit in accordance with a first preferred embodiment of the present invention. Liquid crystal driver 1 drives a pixel-driving circuit including a thin-film transistor (TFT). Light source 2 is formed of a cold cathode fluorescent lamp (hereinafter referred to as a CCFL). Driven by inverter circuit 4, light source 2 produces light. The light is guided by light guide plate 3 to the rear of driver 1. Power-supplying circuit 5, which is formed of a DC/DC converter, provides inverter circuit 4 with power. Operating brightness-control switch 7 allows control circuit 6 to generate a signal for controlling brightness. Switching circuit 8 has keys thereon, which serve just like function keys arranged in a keyboard of a computer. Light-emitting switches 9 contain light-emitting elements, such as a light-emitting diode (hereinafter referred to as an LED). Switch member 10 is formed of rather soft and transparent (or translucent) material. Member 10 is located in front of light-emitting switches 9 so as to pass light from the switches through portions at which markings indicating each function of switches 9 are provided.

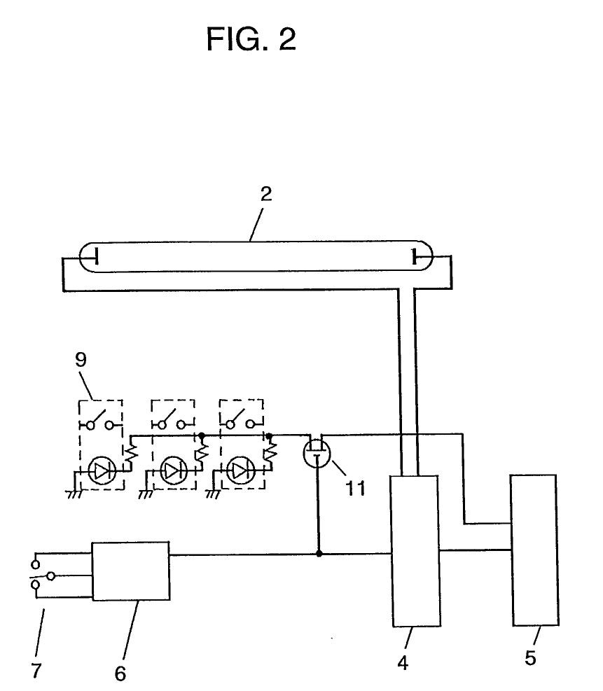

FIG. 2 is a block diagram illustrating a circuit for controlling brightness of backlighting light source 2 of the embodiment.

Here will be described how to adjust brightness of light source 2. In the LCD unit of the embodiment, control circuit 6 controls brightness of light source 2 according to the ratio of the time in which light stays on to the time in which light remains off in a short cycle of about a frequency of 100 Hz : the ratio of 100%-brightness represents the state in which light stays on all the period, similarly, the ratio of 50%-brightness has the state in which light stays on for half the period and remains off for the rest half. Brightness of light source 2 is adjusted according to the ratio. In consideration of outdoors usage, the LCD unit of the present invention has a wide range of adjustment from 100 cd/m² up to 1000 cd/m² so as to be adaptable to ambient light conditions—from in the blare of sunshine to in total darkness.

Control circuit 6 is formed of a semiconductor, such as a one-chip microcomputer. Circuit 6 generates a rectangular clock pulse having high-level portions and low-level portions in synchronization with a frequency of 100 Hz. Control circuit 6 controls the ratio of the high-level portion (hereinafter referred to as the H-level) to the low-level portion (hereinafter as the L-level) of the pulse. Brightness-control switch 7 can be a seesaw switch. Pressing the upper part of the switch provides the period of the H-level with stepwise increase, whereas pressing the lower part of the switch provides the period with stepwise decrease. Holding down the upper part finally eliminates the L-level, so that the output from circuit 6 changes from a square wave to be direct current. Contrarily, holding down the lower part of the switch can shorten the period of the H-level. Suppose that control circuit 6 generates a clock pulse having a ratio of an H-level of 10% to an L-level of 90%, i.e., the clock pulse with a 1:9 H-L ratio. Receiving the pulse, inverter circuit 4 supplies light source 2 with high voltage so that light stays on during the period of the H-level of the pulse. According to the embodiment, the ratio of the H-level can be lowered down to 10%, that is, brightness of source 2 can be weakened to one-tenth of full brightness. Although the explanation above gives an H-level of 10% as the minimum level, it is not limited to: Lowering the ratio of the H-level to 0% allows backlighting source 2 to remain off.

The LCD unit contains switching circuit 8 that has keys for entry operation. The keys of circuit 8 serve just like function keys arranged in a keyboard (not shown). Providing each key with marking indicating an assigned function enhances ease of usage. Besides, for good visual recognition in the dark—in a car in the nighttime, the markings should be clearly visible with the help of light-emitting elements disposed behind the keys.

To serve the need for easy operation, switching circuit 8 of the LCD unit contains at least one light-emitting switch 9. Switch 9 is formed as a combination of a mechanical switch and a light-emitting element including a light-emitting diode (LED). Feeding a current through the LED illuminates switch 9 itself.

Furthermore, switch member 10 covers the front of switch 9. Member 10 has markings printed at a position corresponding to a key-top of switch 9, allowing an operator to easily find a desired function assigned to each switch. Switch member 10 is made of elastic and transparent (or translucent) material. The transparency (or translucency) passes through light from the LED of light-emitting switch 9; the elasticity transmits a force applied from outside member 10 to switch 9. Switch member 10, as shown in FIG. 1, can be formed in one-piece for the keys of switching circuit 8.

Printing the markings “as they are” on the surface of member 10 is a good help to enhance visual recognition. Furthermore, providing the marking as “negative picture”—as is a developed photographic film—generates greater effect because the markings look as if they were in relief, being exposed to light from the LED of switch 9.

Switching circuit 11 connected to switch 9 allows power-supplying circuit 5 to feed a current to the LED of switch 9 during the period of the H-level of the output from control circuit 6. Providing light source 2 with a setting of full brightness, through the operation of brightness-control switch 7, feeds a current to the LED without a break. Similarly, operating switch 7 so as to weaken the intensity of source 2 down to 50%-brightness provides the LED with 50%-brightness. It is thus possible to provide light-emitting switch 9 with brightness control having a ratio the same as that of light source 2.

The LCD unit of the present invention is designed as a motor-vehicle-mounted device having a connection with an information processor typified by a computer. In other words, an operator in a car in the open air is subject to environmental constraints. According to the present invention, however, the LCD unit equipped with light-emitting keys offers easy-to-view by adjusting brightness to changes in ambient light conditions. This contributes to greatly improved convenience of operation.

### Second Preferred Embodiment

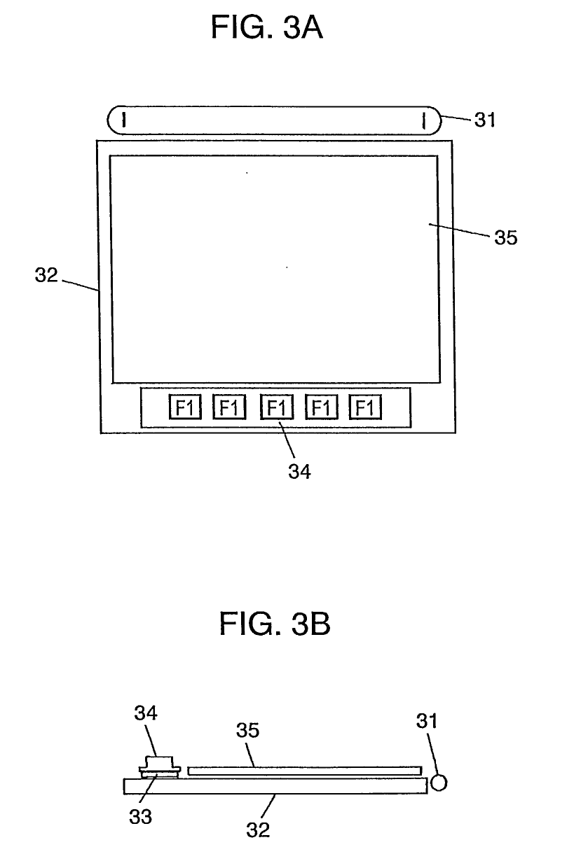

FIGS. 3A and 3B are a front view and a side view, respectively, of an LCD unit in accordance with a second preferred embodiment. The LCD unit of the embodiment includes: i) cold cathode fluorescent lamp (hereinafter referred to as a CCFL) 31 serving as a light source; ii) light guide plate 32; iii) switch section 33; and iv) switch member 34.

Switch member 34 is disposed in front of switch section 33 that is formed of transparent electrodes. Switch member 34 is made of transparent (or translucent) and elastic material and covered with opaque coating from which markings are cut out. Liquid crystal driver 35 determines pixel-by-pixel transmittance of liquid crystal through the application of voltage to the electrodes.

Inverter circuit 4, like the structure of FIG. 1 in the first preferred embodiment, applies high voltage to CCFL 31 to light it on. Receiving a signal from a brightness-control switch, a control circuit (not shown) generates a rectangular clock pulse having high-level portions and low-level portions. The control circuit allows CCFL 31 to remain light on during the period of high-level (hereinafter referred to as the H-level) of the clock pulse, thereby controlling brightness of the LCD. Brightness control of CCFL 31 is the same as that described in the first preferred embodiment and detail explanation thereof will be omitted.

Light guide plate 32 has a surface more extensive than that of liquid crystal driver 35. FIG. 3 shows plate 32 that reaches down to switch section 33 with switch member 34. Switch section 33 is formed of transparent film electrodes. Light guided by plate 32 passes from the rear of switch section 33 through switch member 34.

In the structure above, not only the LCD section of the unit but also switch section are illuminated by light guided by plate 32, so that brightness of the switch section is controlled consistently with that of the LCD section. The LCD unit equipped with illuminating keys thus offers easy-to-view by adjusting brightness to changes in ambient light conditions, promising to greatly improved convenience of operation. Besides, the structure of the embodiment with no need for emitting elements to switch section 33 contributes to manufacturing a simple and economical LCD unit.

The LCD unit of the present invention is used in combination with an information processor typified by a computer.

### Third Preferred Embodiment

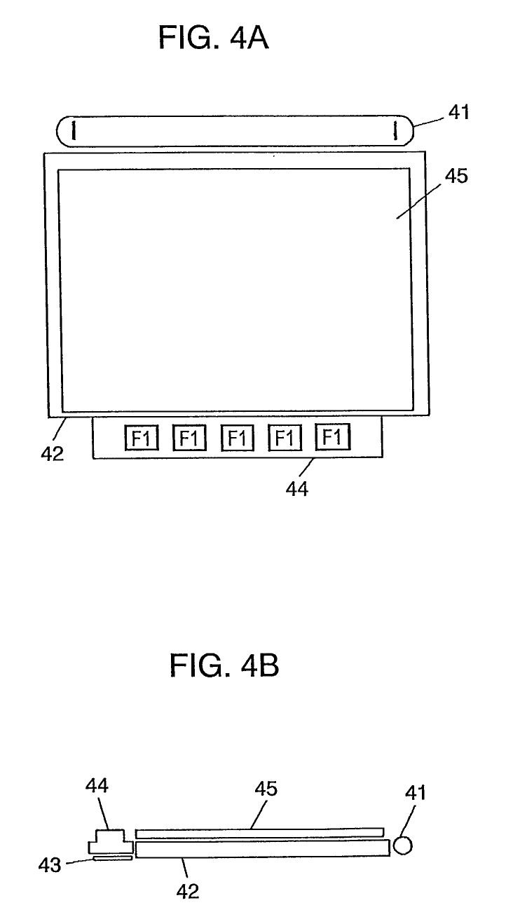

FIGS. 4A and 4B are a front view and a side view, respectively, of an LCD in accordance with a third preferred embodiment.

The LCD unit of the embodiment includes: i) cold cathode fluorescent lamp (hereinafter referred to as a CCFL) 41 serving as a light source; ii) light guide plate 42; iii) switch section 43; and iv) switch member 44. Switch member 44 is disposed in front of switch section 43 that is formed of transparent electrodes. Switch member 44 is made of transparent (or translucent) and elastic material and covered with opaque coating from which markings are cut out. Liquid crystal driver 45 determines pixel-by-pixel transmittance of liquid crystal through the application of voltage to the electrodes.

Inverter circuit 4, like the structure of FIG. 1 in the first preferred embodiment, applies high voltage to CCFL 41 to light it on. Receiving a signal from a brightness-control switch, a control circuit (not shown) generates a rectangular clock pulse having high-level portions and low-level portions. The control circuit allows CCFL 41 to remain light on during the period of high-level (hereinafter referred to as the H-level) of the pulse, thereby controlling brightness of the LCD unit. Brightness control of CCFL 41 is the same as that described in the first preferred embodiment and detail explanation thereof will be omitted.

Light guide plate 42 is disposed adjacent to switch member 44. Switch member 44, as shown in FIG. 4, contacts with its proper thickness to plate 42. Switch section 43 is disposed under member 44.

Switch section 43 may have a film switch or ordinary mechanical switch. Light guided by plate 42 illuminates the interior of switch member 44 through reflection and dispersion, whereby the markings provided on the surface of member 44 is stood out. This allows an operator to have good visual recognition in the dark.

In the structure above, not only the LCD section of the unit but also switch section 43 are illuminated by light guided by plate 42, so that brightness of the switch section is controlled consistently with that of the LCD section. The LCD unit equipped with illuminating keys thus offers easy-to-view by adjusting brightness to changes in ambient light conditions, promising to greatly improved convenience of operation.

According to the structure of the embodiment, there is no need for emitting elements to switch section 33 by virtue of the effective use of light from CCFL 41. In addition, light guide plate 42 can be smaller in size. This contributes to manufacturing a simple and economical LCD unit.

The LCD unit of the present invention is used in combination with an information processor typified by a computer.

According to the embodiments of the present invention, the light passed through the switch member has brightness weaker than that of the light passed through the liquid crystal driver: this is done by controlling an amount of light produced from the LED in the first preferred embodiment, and by increasing a loss of light of the light guide plate in the second and third embodiments. The illuminating keys with properly lessened intensity of light can thus offer easy-to-view over a wide range of ambient light conditions.

The LCD unit of the present invention includes, as described above, at least i) an LCD section having a light source; ii) a plurality of function keys; and iii) a switch member. The function keys are disposed close to the LCD section; the switch member is in front of the keys. The switch member has markings, each of which indicates a function assigned to a key, at positions corresponding to each key-top. The brightness-adjustable LCD with easy-to-use function keys is effectively used in a vehicle in the open air. Particularly, in the case that the LCD unit is mounted on a squad car, a police officer can operate the LCD unit, for example, in a nighttime patrol or in the dark area, with no worry about being exposed to reflections off the emitting LCD. Besides, operating the brightness control switch can phase down brightness not only of the display section but also of the function keys, allowing police officers to work with security in the dark.

What is claimed is:

1. A liquid crystal display (LCD) unit comprising:
a) a light source;
b) an inverter circuit for supplying said light source with power for illuminating;
c) a power-supplying circuit for supplying said inverter circuit with power;
d) a control circuit for adjusting brightness of said light source;
e) an illuminating switch responsible for entry operation to an information processor; and
f) a switch member disposed in front of said illuminating switch, said switch member being made of any one of transparent and translucent material,
wherein controlling output from said inverter circuit according to a signal from said control circuit properly determines brightness of said light source, and brightness of said illuminating switch is controlled by the signal from said control circuit.

2. An LCD unit comprising:
a) a light source;
b) a liquid crystal driver;
c) a light guide plate for guiding light from said light source to behind said liquid crystal driver;
d) an inverter circuit for supplying said light source with power for illuminating;
e) a power-supplying circuit for supplying said inverter circuit with power;
f) a control circuit for adjusting brightness of said light source;
g) a switch section formed of a transparent electrode, said switch section being responsible for entry operation to an information processor;
h) a switch member disposed in front of said switch section, said member being made of any one of transparent and translucent material,
wherein said light guide plate has an area enough to illuminate said liquid crystal driver and said switch section, so that controlling output from said inverter circuit according to a signal from said control circuit determines brightness of said light source consistent with that of said switch section.

3. An LCD unit comprising:
a) a light source;
b) a liquid crystal driver;
c) a light guide plate for guiding light from said light source to behind said liquid crystal driver;
d) an inverter circuit for supplying said light source with power for illuminating;
e) a power-supplying circuit for supplying said inverter circuit with power;
f) a control circuit for adjusting brightness of said light source;
g) a switch section responsible for entry operation to an information processor;
h) a switch member disposed in front of said switch section, said member being made of any one of transparent and translucent material,
wherein said light guide plate, whose one end distant from said light source contacts with said switch member, illuminates said liquid crystal driver by guiding light from said light source to the rear of said liquid crystal driver, said switch member also glows by light brought from the distant end of said light guide plate, so that controlling output from said inverter circuit according to a signal from said control circuit determines brightness of said light source consistently with that of said switch section.

4. The LCD unit as defined in claim 1 through claim 3, wherein light passed through said switch member is lower in brightness than light passed through said liquid crystal driver.

5. The LCD unit as defined in claim 1, wherein said control circuit generates a rectangular clock pulse having high-level portions and low-level portions in which a ratio of said high-level portions to said low-level portions is changeable, said inverter circuit activated during a period of said high-level portions of said clock pulse allows said light source and said illuminating switch to illuminate.

6. An information processor comprising:
an LCD unit including:
a) a light source;
b) an inverter circuit for supplying said light source with power for illuminating;
c) a power-supplying circuit for supplying said inverter circuit with power;
d) a control circuit for adjusting brightness of said light source;
e) an illuminating switch responsible for entry operation to said information processor; and
f) a switch member disposed in front of said illuminating switch, said switch being made of any one of transparent and translucent material,
wherein controlling output from said inverter circuit according to a signal from said control circuit properly determines brightness of said light source, and brightness of said illuminating switch is controlled by the signal from said control circuit.

7. An information processor comprising:
an LCD unit including:
a) a light source;
b) a liquid crystal driver;
c) a light guide plate for guiding light from said light source to behind said liquid crystal driver;
d) an inverter circuit for supplying said light source with power for illuminating;
e) a power-supplying circuit for supplying said inverter circuit with power;
f) a control circuit for adjusting brightness of said light source;
g) a switch section formed of a transparent electrode, said switch section being responsible for entry operation to said information processor;
h) a switch member disposed in front of said switch section, said member being made of any one of transparent and translucent material,
wherein said light guide plate has an area enough to illuminate said liquid crystal driver and said switch section, so that controlling output from said inverter circuit according to a signal from said control circuit determines brightness of said light source consistent with that of said switch section.

8. An information processor comprising:
an LCD unit including:
a) a light source;
b) a liquid crystal driver;
c) a light guide plate for guiding light from said light source to behind said liquid crystal driver;
d) an inverter circuit for supplying said light source with power for illuminating;
e) a power-supplying circuit for supplying said inverter circuit with power;
f) a control circuit for adjusting brightness of said light source;
g) a switch section responsible for entry operation to said information processor;
h) a switch member disposed in front of said switch section, said member being made of any one of transparent and translucent material,
wherein said light guide plate, whose one end distant from said light source contacts with said switch member, illuminates said liquid crystal driver by guiding light from said light source to the rear of said liquid crystal driver, said switch member also glows by light brought from the distant end of said light guide plate, so that controlling output from said inverter circuit according to a signal from said control circuit determines brightness of said light source consistent with that of said switch section.
